(19) United States
(12) Patent Application Publication
(10) Pub. No.: US 2016/0116393 A1
(43) Pub. Date: Apr. 28, 2016

(54) PARTICLE ARRANGING DEVICE AND METHOD

(71) Applicants: Senplus Inc., Gyeonggi-do (KR); Korea Advanced Institute Of Science And Technology, Daejeon (KR)

(72) Inventors: Young-Ho Cho, Daejeon (KR); Jong-Uk Bu, Gyeonggi-do (KR); Jiyoon Bu, Daejeon (KR)

(73) Assignees: KOREA ADVANCED INSTITUTE OF SCIENCE AND TECHNOLOGY, Daejeon (KR); SENPLUS INC., Gyeonggi-do (KR)

(21) Appl. No.: 14/921,747

(22) Filed: Oct. 23, 2015

(30) Foreign Application Priority Data
Oct. 24, 2014 (KR) 10-2014-0145467

(51) Int. Cl. G01N 15/10; B01L 3/00

(52) U.S. Cl. CPC G01N 15/1056; B01L 3/502761; B01L 3/502746; B01L 3/502715; B01L 2200/0652; B01L 2300/0877; B01L 2400/082; B01L 2300/123; B01L 2300/18; G01N 2015/1081

(57) ABSTRACT

A particle arranging device includes a chamber including a first input/output portion and a second input/output portion and providing a space through which a fluid containing particles flows, at least one capturing structure provided in the chamber to form a fluidic channel through which the fluid flows and having a gate portion adapted to allow the particle in the fluid to enter the capturing structure through the gate portion and a receiving portion adapted to receive the particle entering through the gate portion, a deformable membrane structure provided in the gate portion of the capturing structure and configured to actuate to control the number of the particles to enter the capturing structure through the gate portion, and a membrane control portion configured to apply a pressure to the deformable membrane structure.

### PRIORITY STATEMENT

This application claims priority under 35 USC §119 to Korean Patent Application No. 10-2014-0145467, filed on Oct. 24, 2014 in the Korean Intellectual Property Office (KIPO), the contents of which are herein incorporated by reference in their entirety.

### FIELD OF THE DISCLOSURE

Example embodiments relate to a particle arranging device and associated methods. More particularly, example embodiments relate to a device and associated methods of arranging particles in a fluid flowing through a micro fluidic channel.

### BACKGROUND OF THE DISCLOSURE

A micro fluidic system may be widely used in fields of chemistry, biology and material. Particularly, as application of bio-related equipment becomes more important, micro fluidic systems may be used to process micro-particles such as biological materials in micro fluids, LOC (Lab on a chip), DDS (Drug Delivery System), and/or the like.

Various technologies for processing a cell in a fluid have been proposed and developed. For example, a bio chip using an electric field and/or a magnetic field, a device using centrifugal force, laser tweezers based on an optical force, and/or the like may be used to separate, sort, hold, collect, inspect, and/or manipulate the particles in a fluid.

However, these technologies may require a complicated preprocessing of the particle and/or a persistent monitoring of the captured particle. It may be difficult to make a combination of desired particles and/or provide for the self-arrangement of the particles. Further, with some technologies such as, for example, laser tweezers, it is difficult to manipulate many particles at a time, which may result in a low throughput.

### SUMMARY OF THE DISCLOSURE

Example embodiments provide a particle arranging device with a high throughput capable of arranging micro-particles in a fluidic channel precisely.

According to example embodiments, a particle arranging device includes a chamber including a first input/output portion and a second input/output portion and providing a space through which a fluid containing particles flows, at least one capturing structure provided in the chamber to form a fluidic channel through which the fluid flows and having a gate portion adapted to allow the particle in the fluid to enter the capturing structure through the gate portion and a receiving portion adapted to receive the particle entering through the gate portion, a deformable membrane structure provided in the gate portion of the capturing structure and configured to actuate to control the number of the particles to enter the capturing structure through the gate portion, and a membrane control portion configured to apply a pressure to the deformable membrane structure.

In example embodiments, the capturing structure may include at least first and second channel patterns formed on an inner wall of the chamber to form the fluidic channel. The first and second channel patterns may be arranged to face each other to form the gate portion and the receiving portion.

In example embodiments, the deformable membrane structure may include a plurality of gate membrane portions arranged sequentially in the gate portion along an extending direction of the gate portion.

In example embodiments, the gate membrane portion may be deformed by the applied pressure to block the particle from entering through the gate portion.

In example embodiments, the gate membrane portion may have a width capable of blocking the particle from entering through the gate portion.

In example embodiments, the membrane control portion may include a membrane pressurizing portion adapted to apply the pressure to the gate membrane portion.

In example embodiments, a plurality of the membrane pressurizing portions may be arranged to correspond to the gate membrane portions.

In example embodiments, the membrane control portion may include a recess formed in an inner wall of the chamber to extend across the gate portion of the capturing structure.

In example embodiments, the deformable membrane structure may include a deformable membrane to cover the recess.

In example embodiments, the membrane control portion may be connected to a pneumatic supply source and configured to deform a gate membrane portion of the deformable membrane structure.

In example embodiments, the membrane control portion may include a membrane pressurizing portion to form an airtight space with the deformable membrane structure and a membrane control heater disposed in the airtight space to increase temperature of an internal air of the airtight space, thereby deforming the gate membrane portion.

In example embodiments, a plurality of the capturing structures may be arranged in a first direction to form one capturing array, and a plurality of the capturing arrays may be arranged in a second direction substantially perpendicular to the first direction.

According to example embodiments, a particle arranging device includes a chamber including a first input/output portion and a second input/output portion and providing a space through which a fluid containing particles flows, at least one capturing array including a plurality of capturing structures, the capturing structure provided in the chamber to form a fluidic channel through which the fluid flows, the capturing structure having a gate portion adapted to allow the particle in the fluid to enter the capturing structure through the gate portion and a receiving portion adapted to receive the particle entering through the gate portion, a deformable membrane structure including at least one gate membrane portion, the gate membrane portion provided in each of the gate portions of the capturing structures and configured to actuate to control the number of the particles to enter the capturing structure through the gate portion, and a membrane control line including a membrane pressurizing portion, the membrane pressurizing portion extending to cross the gate portions of the capturing structures and configured to apply a pressure to the gate membrane portion.

In example embodiments, the capturing structure may include at least first and second channel patterns formed on an inner wall of the chamber to form the fluidic channel.

In example embodiments, a plurality of the gate membrane portions may be arranged sequentially in the gate portion.

In example embodiments, the receiving portion may have a length greater than a length of the gate.

In example embodiments, the capturing structures may be arranged in a first direction, and a plurality of the capturing arrays may be arranged in a second direction substantially perpendicular to the first direction.

According to example embodiments, a micro-particle arranging device may include a reversibly actuatable micro-balloon actuator arranged in a fluidic channel of a capturing structure. The micro-balloon actuator may be used as a resisting structure in the fluidic channel to control the number of particles to be allowed to enter the capturing structure.

Accordingly, the micro-particle arranging device may provide a high throughput self-arrangement of the micro-particles, excellent reproducibility, and a simple combination arrangement of different types of particles.

### BRIEF DESCRIPTION OF THE DRAWINGS

Example embodiments will be more clearly understood from the following detailed description taken in conjunction with the accompanying drawings. FIGS. 1 to 22 represent non-limiting, example embodiments as described herein.

FIG. 1 is an exploded perspective view illustrating a particle arranging device in accordance with example embodiments.

FIG. 2 is a plan view illustrating the particle arranging device in FIG. 1.

FIG. 3 is a plan view illustrating capturing structures in FIG. 1.

FIG. 4 is an enlarged view illustrating the capturing structure in FIG. 3.

FIG. 5 is a plan view illustrating membrane control lines in FIG. 1.

FIG. 6 is an enlarged view illustrating the A portion in FIG. 5.

FIG. 7 is a cross-sectional view taken along the A-A′ line in FIG. 2.

FIGS. 8A to 8C are plan views illustrating the capturing structure and the membrane control lines in FIG. 2.

FIGS. 9A to 9C are cross-sectional views respectively taken along the B-B′ lines in FIGS. 8A to 8C.

FIGS. 10A to 10F are plan views illustrating a method of arranging micro-particles in accordance with example embodiments.

FIG. 11 is a plan view illustrating membrane control lines of a particle arranging device in accordance with example embodiments.

FIG. 12 is a plan view illustrating a membrane control line of a particle arranging device in accordance with example embodiments.

FIG. 13 is a cross-sectional view taken along the C-C′ line in FIG. 12.

FIGS. 14A to 14C are cross-sectional views illustrating deformation of gate membrane portions in FIG. 13.

FIG. 15 is a plan view illustrating a membrane control line of a particle arranging device in accordance with example embodiments.

FIGS. 16A to 16D are plan views illustrating a capturing structure of a particle arranging device in accordance with example embodiments.

FIGS. 17A to 17C are plan views illustrating capturing arrays of a particle arranging device in accordance with example embodiments.

FIGS. 18A to 18C are plan views illustrating membrane control lines respectively corresponding to the capturing arrays in FIGS. 17A to 17C.

FIG. 19 is a plan view illustrating a first input/output portion in accordance with example embodiments.

FIG. 20 is a plan view illustrating a second input/output portion in accordance with example embodiments.

FIGS. 21A and 21B are plan views illustrating a chamber of a particle arranging device in accordance with example embodiments.

FIG. 22 is a cross-sectional view illustrating a particle arranging device in accordance with example embodiments.

### DETAILED DESCRIPTION OF THE ASPECTS OF THE DISCLOSURE

Various example embodiments will be described more fully hereinafter with reference to the accompanying drawings, in which some example embodiments are shown. The present inventive concept may, however, be embodied in many different forms and should not be construed as limited to the example embodiments set forth herein. Rather, these example embodiments are provided so that this description will be thorough and complete, and will fully convey the scope of the present inventive concept to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third, fourth etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive concept.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized example embodiments (and intermediate structures). As such, variations from the illustrated shapes of example embodiments as a result of, for example, manufacturing techniques and/or tolerances, are to be expected. Thus, example embodiments should not be construed as being limited to the particular shapes and/or regions illustrated herein but are to include deviations in shapes that may result, for example, from manufacturing.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

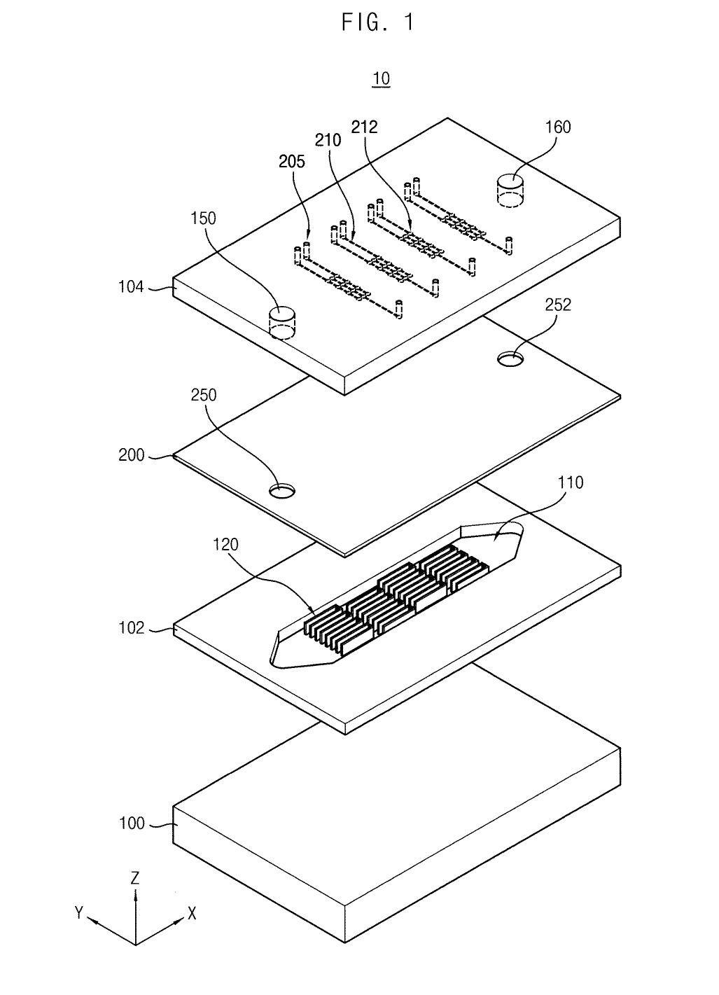

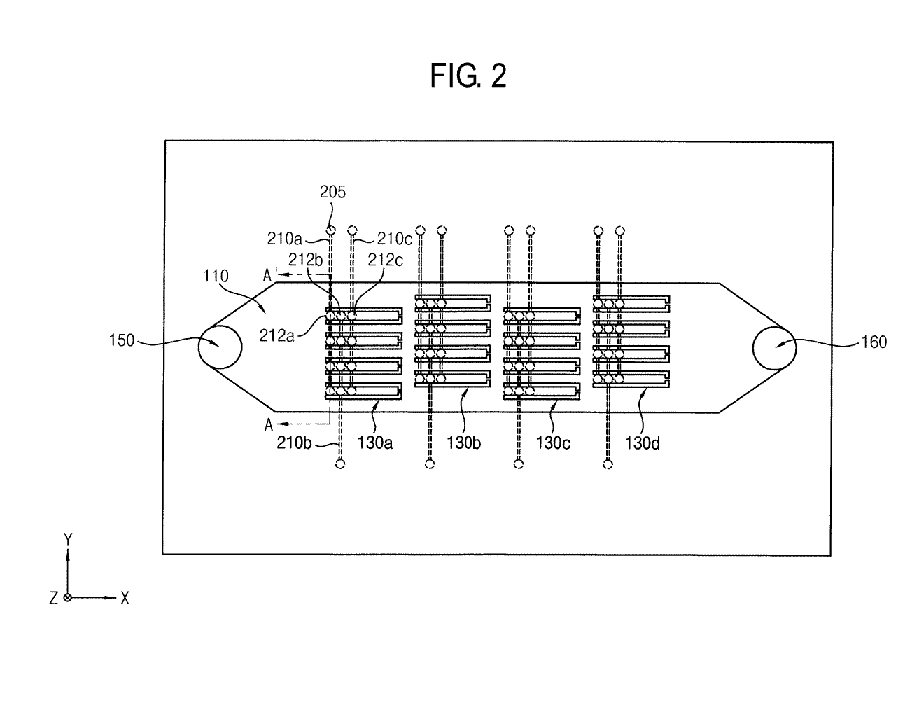

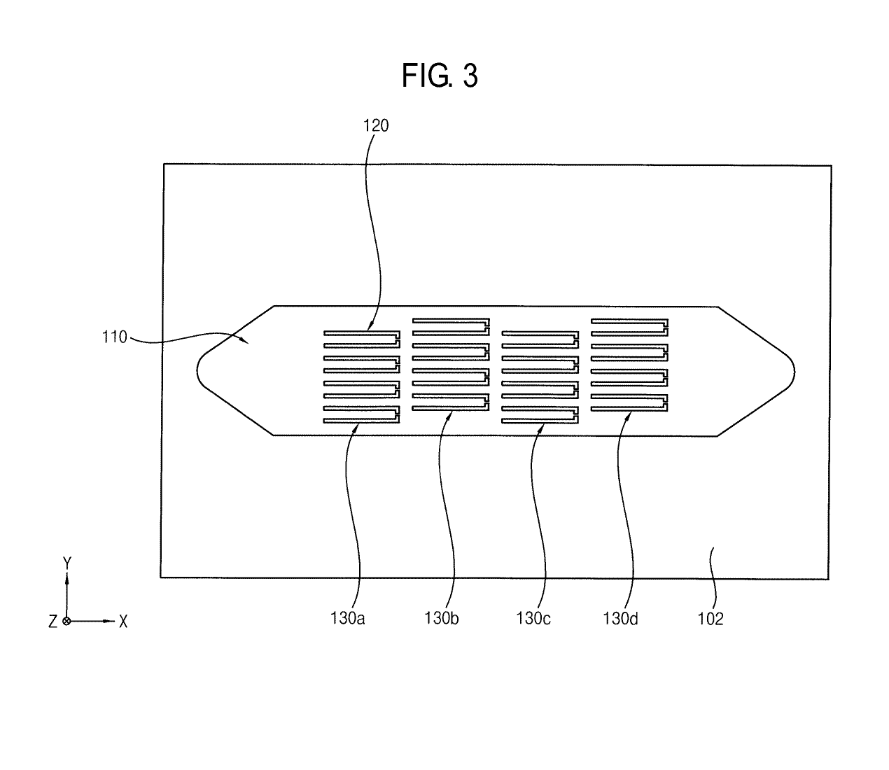

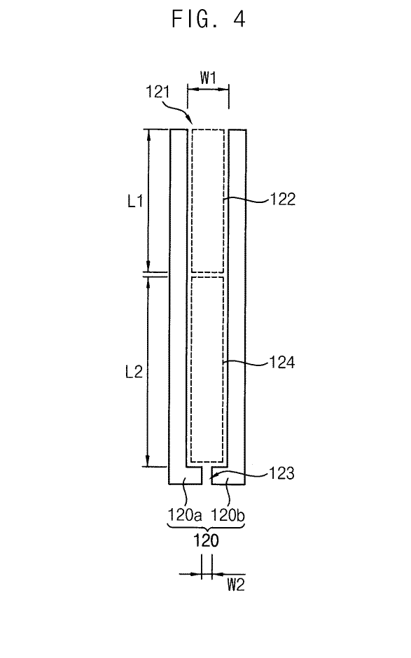

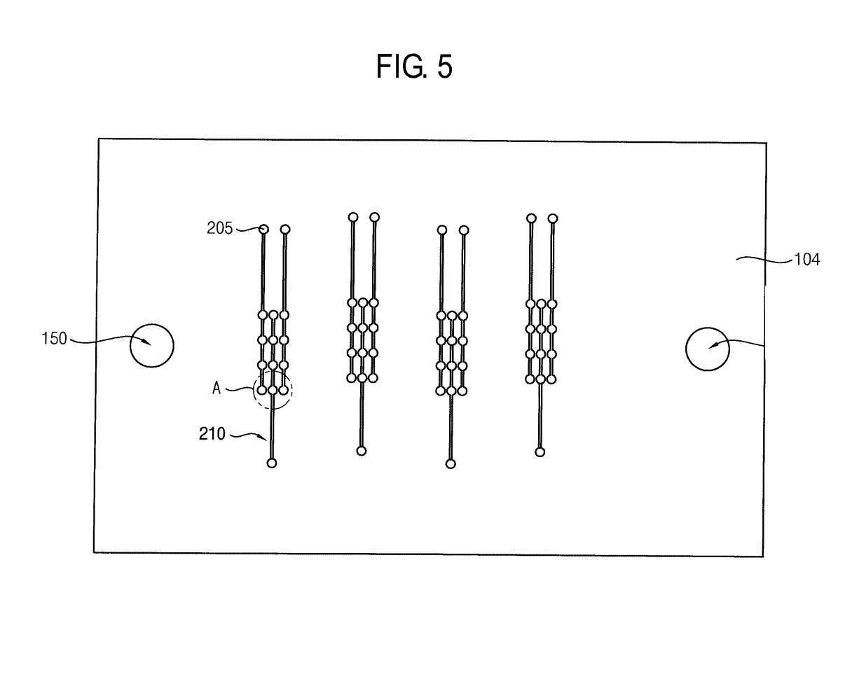

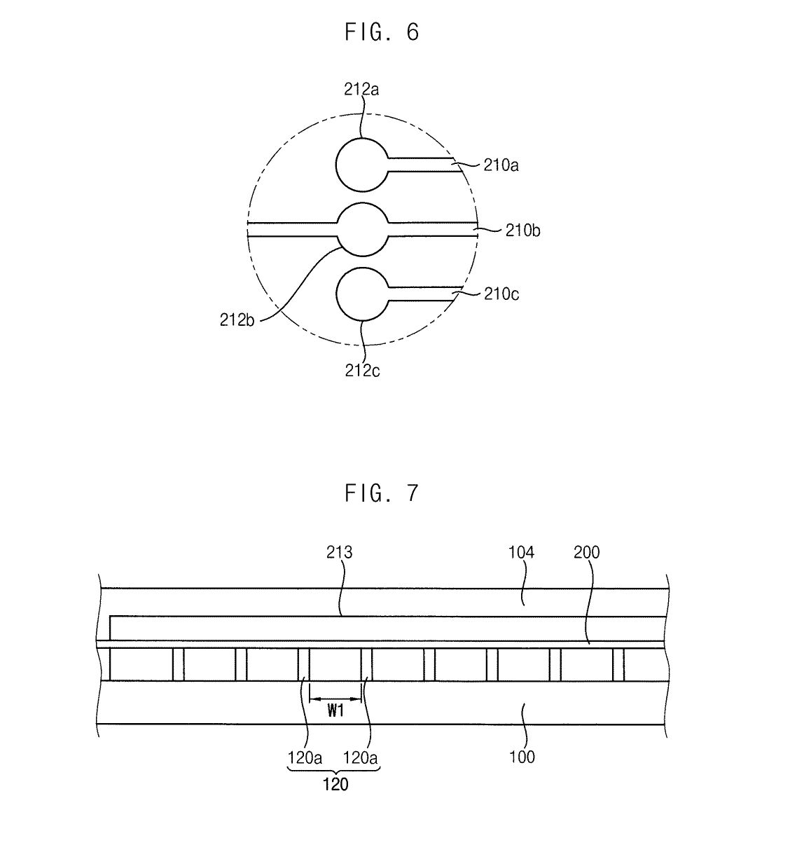

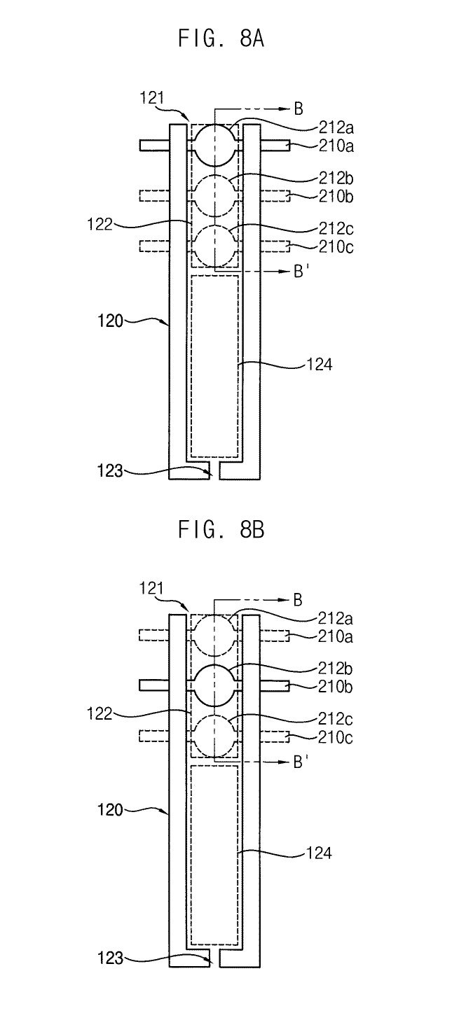

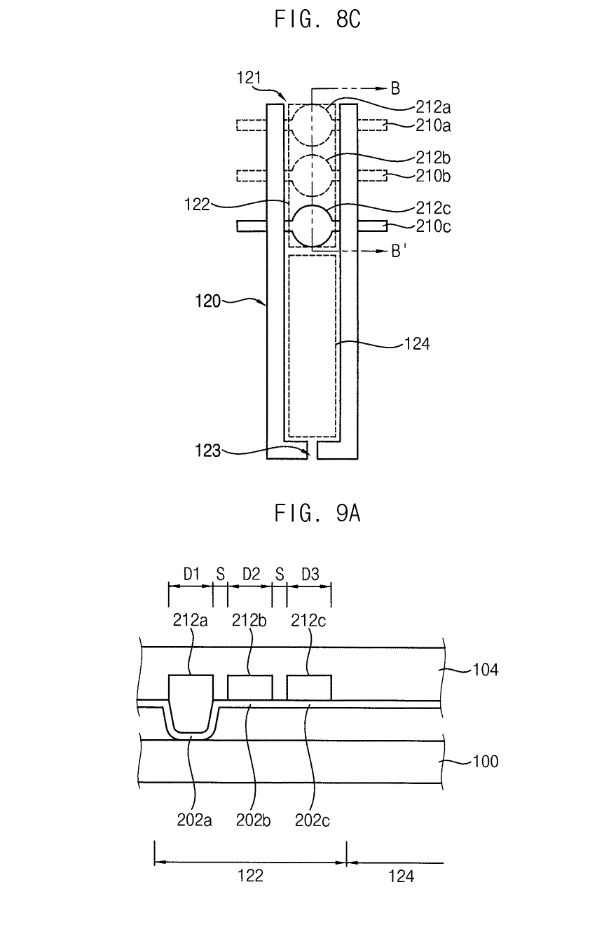

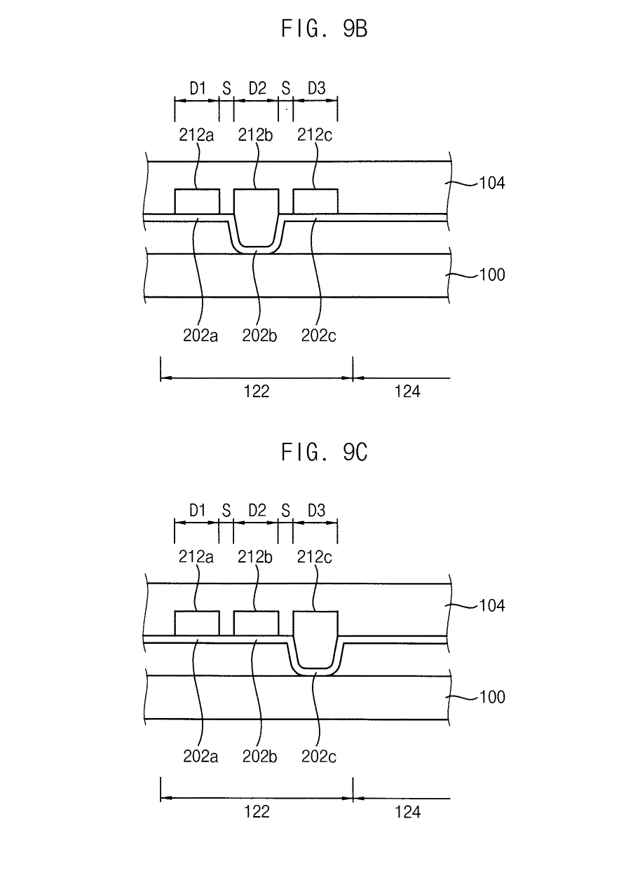

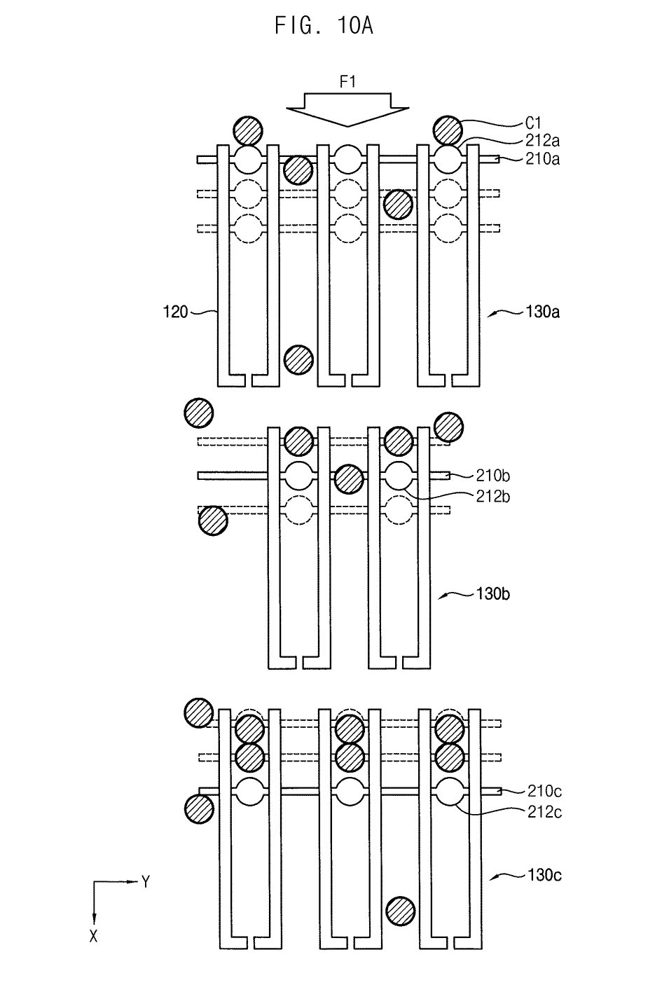

FIG. 1 is an exploded perspective view illustrating a particle arranging device in accordance with example embodiments. FIG. 2 is a plan view illustrating the particle arranging device in FIG. 2. FIG. 3 is a plan view illustrating capturing structures in FIG. 1. FIG. 4 is an enlarged view illustrating the capturing structure in FIG. 3. FIG. 5 is a plan view illustrating membrane control lines in FIG. 1. FIG. 6 is an enlarged view illustrating the A portion in FIG. 5. FIG. 7 is a cross-sectional view taken along the A-A′ line in FIG. 2. FIGS. 8A to 8C are plan views illustrating the capturing structure and the membrane control lines in FIG. 2. FIGS. 9A to 9C are cross-sectional views respectively taken along the B-B′ lines in FIGS. 8A to 8C.

Referring to FIGS. 1 to 9C, a particle arranging device 10 may include a chamber 110, at least one capturing array 130a, 130b, 130c, 130d having a plurality of capturing structures 120 respectively configured to form a fluidic channel in the chamber 110 and configured to selectively capture a micro-particle in a fluid flowing through the fluidic channel. The particle arranging device 10 may include a deformable membrane structure operably engaged with the capturing structure 120, and a membrane control line 210 adapted as a membrane control portion configured to selectively apply a pressure to the deformable membrane structure.

In some example embodiments, the chamber 110 may include a first input/output portion 150 and a second input/output portion 160. The first input/output portion 150 and the second input/output portion 160 may be disposed proximate opposing ends of the chamber 110 respectively. The chamber 110 may provide a space for fluid flow. The chamber 110 may have a polygonal shape when seen in plan view. For example, as shown in FIG. 1, the chamber 110 may have a hexagonal shape when seen in plan view. Although illustrated as having a hexagonal shape, one of ordinary skill in the art may appreciate the shape of the chamber 110 is not limited thereto and may have a circular shape, a rectangular shape, a polygonal shape, and/or the like.

The fluid may enter the chamber 110 through the first input/output portion 150 and may exit the chamber 110 through the second input/output portion 160. In another aspect, a collecting fluid may flow into the chamber 110 through the second input/output portion 160 and flow out of the chamber 110 through the first input/output portion 150. For example, at least one fluid transfer element (not illustrated) may be connected to the first input/output portion 150 and/or the second input/output portion 160 and may be configured to supply the fluid into the chamber 110 and/or remove the fluid from the chamber 110. Additionally or alternatively, the fluid may be transferred through the chamber 110 by rotating or tilting the device 10. In this case, the rotational speed, the rotational acceleration and/or the rotational direction of the chamber 110, and/or the inclination, orientation, and/or the like of the device 10 may be controlled to adjust the flow rate of the fluid.

In some aspects, the fluid may be a solution that includes biochemical particles. For example, the solution may include blood, bodily fluids, cerebrospinal fluids, urine, sputum, a mixture thereof, or a diluted solution thereof. Additionally, the exemplary particles disposed in the solution may include tissues, cells, proteins, nucleic acids, an aggregate thereof, or a mixture thereof.

The chamber 110, the capturing structures 120, the deformable membrane structure and/or the membrane control line 210 may be formed by, for example, semiconductor manufacturing processes such as photolithography, ion lithography, electron lithography, and/or the like. The chamber 110 may be formed using polymer material (e.g., polydimethylsiloxane (PDMS), polymethylmethacrylate (PMMA), SU-8, and/or the like) and/or inorganic material (e.g., glass, quartz, silicon, and/or the like).

As illustrated in FIGS. 1 and 2, the particle arranging device 10 may include a first substrate 100, a second substrate 102, a deformable membrane 200, and a third substrate 104 that are assembled in a stacked relationship with respect to one another. For example, the first substrate 100, the second substrate 102, the deformable membrane 200, and the third substrate 104 may be arranged with respect to one another such that the first substrate 102 substantially abuts the second substrate 102, the second substrate 102 substantially abuts the first substrate 100 and the deformable membrane 200, the deformable membrane 200 substantially abuts the second substrate 102 and the third substrate 104, and the third substrate 104 substantially abuts the deformable membrane 200.

In some aspects, the second substrate 102 may be formed on the first substrate 100, and the second substrate 102 may partially define the chamber 110. The first, second, third, and fourth capturing arrays 130a, 130b, 130c, 130d may each include a plurality of the capturing structures 120 and may be arranged within the chamber 110. The first, second, third, and fourth capturing arrays 130a, 130b, 130c, 130d may be arranged sequentially along a first direction (direction along X-axis) from the first input/output portion 150 to the second input/output portion 160 in the chamber 110. Alternatively, an opening may be formed in a single substrate so as to define the chamber, and the capturing structures may be formed in the opening of the single substrate.

According to some aspects, the deformable membrane 200 may be stacked on the second substrate 102, and the third substrate 104 may be stacked on the second substrate 102. According to one aspect, the deformable membrane 200 may substantially abut the second substrate 102 and the third substrate 104. That is, the deformable membrane 200 may be disposed interposed between the second substrate 102 and the third substrate 104. The deformable membrane 200 may operably engage the second substrate 102 so as to enclose the chamber 110, cover the capturing structures 120, and define at least one fluidic channel. The fluidic channel may be defined by an upper surface of the first substrate 100, a lower surface of the deformable membrane 200 and the capturing structure 120. The third substrate 104 may define the at least one membrane control line 210 configured to deform a portion of the deformable membrane (i.e., the deformable membrane structure), which forms a portion of the fluidic channel.

In particular, the third substrate 104 may define a recess 213 that opens towards the first and second substrates 100, 102 when the first substrate 100, the second substrate 102, the deformable membrane 200, and the third substrate 104 are arranged to form the particle arranging device 10. The recess 213 may form the membrane control line 210 and extend along a second direction (direction along Y-axis) that is perpendicular to the first direction. The deformable membrane 200, when operably engaged with the third substrate 104, may cover the recess 213 so as to provide the deformable membrane structure, which constitutes one wall of the fluidic channel. In some aspects, the upper surface of the first substrate 100 may constitute a bottom wall of the chamber 110 and/or the fluidic channel, and the lower surface of the third substrate 104 may constitute an upper wall of the chamber 110.

A plurality of the recesses may be formed in the lower surface of the third substrate 104 to form a plurality of the membrane control lines. For example, first, second and third membrane control lines 210a, 210b, 210c may be arranged spaced apart from each other along the first direction respectively. The first, second and third membrane control lines 210a, 210b, 210c may extend along the second direction and may extend across the at least one capturing structure 120, respectively. Thus, deformable membrane structures 202a, 202b and 202c may be formed in a single capturing structure 120. The deformable membrane structures 202a, 202b and 202c may be deformed when a pressure (i.e, a force) is applied to the deformable membrane structures.

The deformable membrane 200 may define a first hole 250 that is in fluid communication with the first input/output portion 150. Additionally or alternatively, the deformable membrane 200 may define a second hole 252 that is in fluid communication with the second input/output portion 160. Accordingly, the fluid may be introduced to the chamber 110 via the first hole 250 and the first input/output portion 150, and the fluid may be removed from the chamber 110 via the second input/output portion 160 and the second hole 252.

When a fluid flows in a first flow direction from the first input/output portion 150 to the second input/output portion 160 in the chamber 110, the fluid may pass sequentially through the first, second, third and fourth capturing arrays 130a, 130b, 130c, 130d. In some embodiments, the first flow direction may provide for capturing particles in the fluid.

When a fluid flows in a second flow direction from the second input/output portion 160 to the first input/output portion 150 in the chamber 110, the fluid may pass sequentially through the fourth, third, second and first capturing arrays 130d, 130c, 130b, 130a, and may provide for collecting the captured particles.

The first capturing array 130a may include a plurality of the capturing structures 120 arranged spaced from each other along the second direction (direction along Y-axis) perpendicular to the first direction. Similarly, the second, third, and fourth capturing arrays 130b, 130c, 130d may include a plurality of the capturing structures 120 arranged substantially the same as or similar to the capturing structures 120 of the first capturing array 130a.

As illustrated in FIG. 4, the capturing structure 120 may include a pair of first and second channel patterns 120a, 120b disposed within the chamber 110 so as to form a fluidic channel through which a fluid may flow. In some embodiments, the pair of first and second channel patterns 120a, 120b may be disposed on an inner wall that partially defines the chamber 110. The first and second channel patterns 120a, 120b may be shaped symmetrically with respect to each other. The first and second channel patterns 120a, 120b may be arranged to face each other so as to form a gate portion 122 and a receiving portion 124. Front end portions of the first and second channel patterns 120a, 120b may define an inlet 121 through which fluid flows into the gate portion 122 of the capturing structure 120. Opposing rear end portions of the first and second channel patterns 120a, 120b may define an outlet 123 through which the fluid flows out of the receiving portion 124 of the capturing structure 120.

The inlet 121 of the capturing structure 120 may have a first size (e.g., width W1) such that a deformable particle in the fluid can enter the capturing structure 120 while being deformed under a hydraulic pressure. The outlet 123 of the capturing structure 120 may have a second size (e.g., width W2) such that the deformable particle in the fluid cannot escape the capturing structure 120 even though the particle is deformed under a hydraulic pressure. The gate portion 122 may have a first width W1 and the receiving portion 124 may have a second width the same as or greater than the first width W1. The gate portion 122 may have a first length L1 and the receiving portion 124 may have a second length L2 the same as or greater than the first length L1. The lengths of the gate portion 122 and the receiving portion 124 may be determined with consideration towards the number and sizes of the micro-particles to be captured.

When a fluid flows in the first flow direction in the chamber 110, the fluid may pass through the fluidic channel of the capturing structure 120. As mentioned herein, when the gate portion 122 is opened, the particle in the fluid may enter the capturing structure 120 through the gate portion 122 so as to be captured in the receiving portion 124 of the capturing structure 120.

As illustrated in FIGS. 2, 8A to 9C, the first, second and third membrane control lines 210a, 210b, 210c may extend across the gate portions 122 defined by the capturing structures 120 of one capturing array respectively. The first, second and third membrane control lines 210a, 210b, 210c may include first, second and third membrane pressurizing portions 212a, 212b, 212c configured to expand the corresponding portions of the deformable membrane 200 in the gate portion 122, respectively. The first, second and third membrane pressurizing portions 212a, 212b, 212c may have a circular shape when seen in plan view.

Accordingly, first, second and third gate membrane portions 202a, 202b, 202c may be disposed in the gate portion 122 of the capturing structure 120 to be controlled by the first, second and third membrane pressurizing portions 212a, 212b, 212c, respectively. Thus, the deformable membrane structure may include the first, second and third gate membrane portions 202a, 202b, 202c, which may be sequentially arranged in the gate portion 122 respectively. The first, second and third membrane control lines 210a, 210b, 210c may be connected to individual pneumatic supply sources 205 respectively to control the first, second and third gate membrane portions 202a, 202b, 202c independently from one another.

As illustrated in FIGS. 8A and 9A, when a force (e.g., air pressure) is applied to the first membrane control line 210a, the first membrane pressurizing portion 212a may deform the first gate membrane portion 202a. The first gate membrane portion 202a may be deformed by the applied pressure to close the gate portion 122 such that a particle in the fluid is blocked from passing through the gate portion 122 of the capturing structure 120. The first gate membrane portion 202a may be arranged adjacent to the inlet 121 of the capturing structure 120 and may be configured to be deformable so as to close the gate portion 122 to prevent a particle in the fluid from entering the capturing structure 120. When the application of the force (e.g., air pressure) to the first membrane control line 210a ceases, the first gate membrane portion 202a may elastically return to its original position, shape, properties, and/or the like.

In this regard, the first membrane pressurizing portion 212a may have a first diameter D1, the second membrane pressurizing portion 212b may have a second diameter D2, and the third membrane pressurizing portion 212c may have a third diameter D3. The diameters D1, D2, D3 of the first, second and third membrane pressurizing portions 212a, 212b, 212c may be the same as each other. In some aspects, the first, second, and third diameters D1, D2, D3 may differ from each another. Diameters of the first, second, and third gate membrane portions may be determined by the diameters of the first, second, and third membrane pressurizing portions. The first, second, and third gate membrane portions may have a width (i.e., diameter) that corresponds to a diameter of the particle to be captured. Accordingly, the first, second, and third gate membrane portions may have a width (i.e., diameter) capable of blocking the particle from entering the capturing structure 120 through the gate portion 122.

As illustrated in FIGS. 8B and 9B, when a force (e.g., air pressure) is applied to the second membrane control line 210b, the second membrane pressurizing portion 212b may deform the second gate membrane portion 202b. The second gate membrane portion 202b may be deformed by the applied force to close the gate portion 122 such that the particle in the fluid may be blocked from entering and/or passing through the gate portion 122. When the air pressure is discharged from the second membrane control line 210b, the second gate membrane portion 202b may be returned elastically to its original position.

As illustrated in FIGS. 8C and 9C, when a force (e.g., air pressure) is applied to the third membrane control line 210c, the third membrane pressurizing portion 212c may deform the third gate membrane portion 202c. The third gate membrane portion 202c may be deformed by the applied force to close the gate portion 122 such that the particle in the fluid is blocked from entering and/or passing through the gate portion 122. When the air pressure is discharged from the third membrane control line 210c, the third gate membrane portion 202c may be returned elastically to its original position.

The first gate membrane portion 202a and the second gate membrane portion 202b may be spaced from each other by a predetermined distance S, and the second gate membrane portion 202b and the third gate membrane portion 202c may be spaced apart from each other by a predetermined distance S. The spacing distance between the gate membrane portions may be determined with consideration towards the number and sizes of the particles to be selectively blocked from entering and/or passing through the gate portion 122.

As mentioned above, at least two gate membrane portions may be arranged in the gate portion 122 of the capturing structure 120 and may be pressurized by corresponding membrane pressurizing portions to serve as a micro-balloon actuator. The micro-balloon actuators may be selectively actuated to control the number of the particles which are allowed to enter the capturing structure 120 through the gate portion 122 and captured in the receiving portion 124 of the capturing structure 120.

In some aspects, when the number of the gate membrane portions is N, the maximum number of the captured particles may be N−1. For example, when three gate membrane portions are arranged in the gate portion 122 of the capturing structure 120 to serve as three micro-balloon actuators, the number of the particles that may be retained in the receiving portion 124 may be 0, 1 or 2. However, it may not be limited thereto, it may be understood that the size (width) of the gate membrane portion(s) may be adjusted to control the maximum number of the particles to be captured.

Although not illustrated in the figures, a thickness of the deformable membrane structure may be increased continuously or stepwise along the fluid flow direction. For example, the first gate membrane portion 202a may have a first thickness, the second gate membrane portion 202b may have a second thickness greater than the first thickness, and the third gate membrane portion 202c may have a third thickness greater than the first and/or second thickness. Accordingly, when a force applied to the first, second and third membrane control lines 210a, 210b, 210c is identical, the first, second and third gate membrane portions may be deformed differently with respect to each other depending on their respective thicknesses. As a result, the cross-sectional area of the fluidic channel through which the fluid flows may be controlled by the thickness of the deformable membrane structure.

Hereinafter, a method of arranging micro-particles using the device in FIG. 1 will be explained in detail.

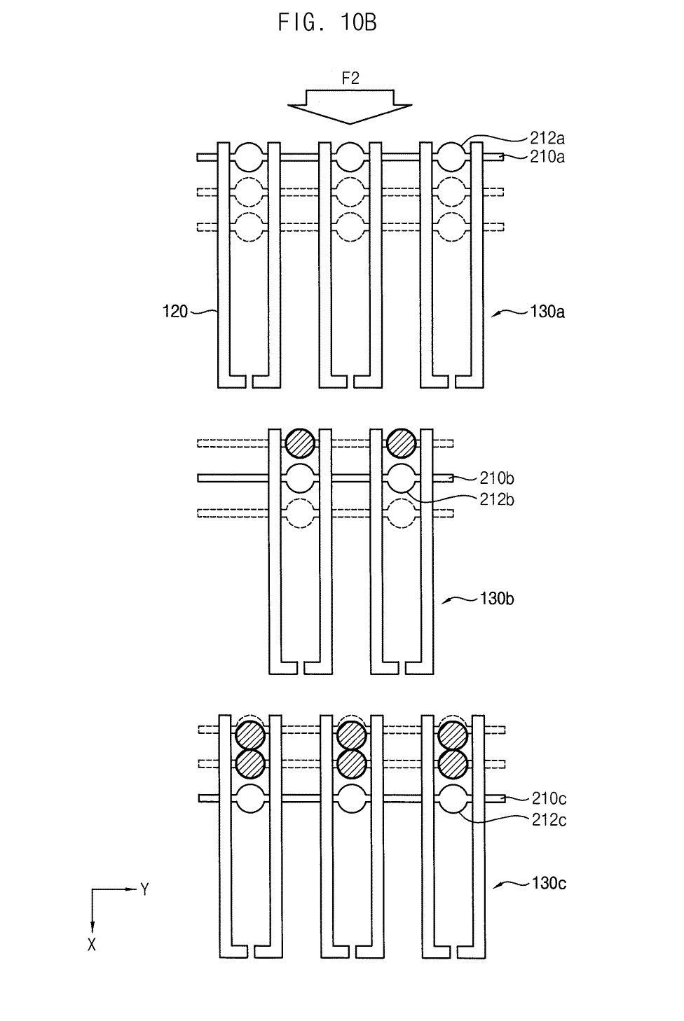

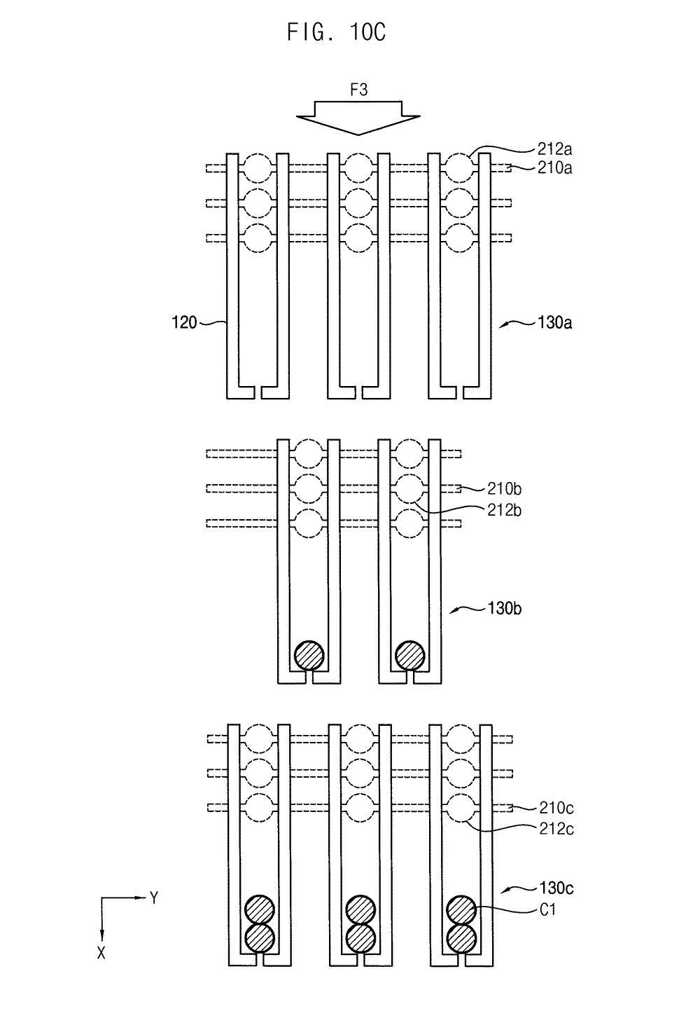

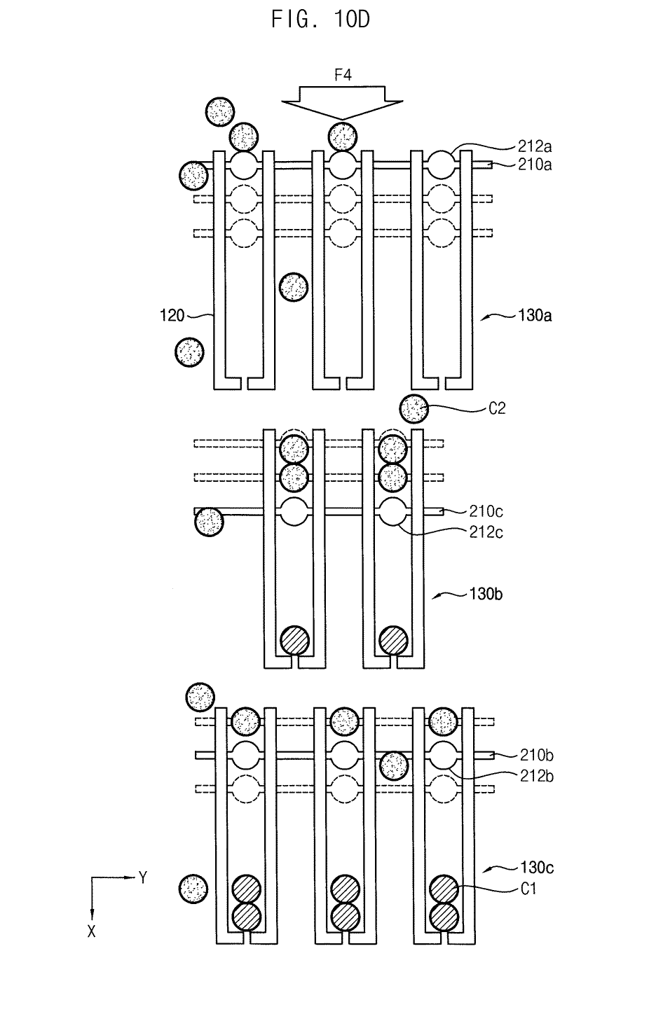

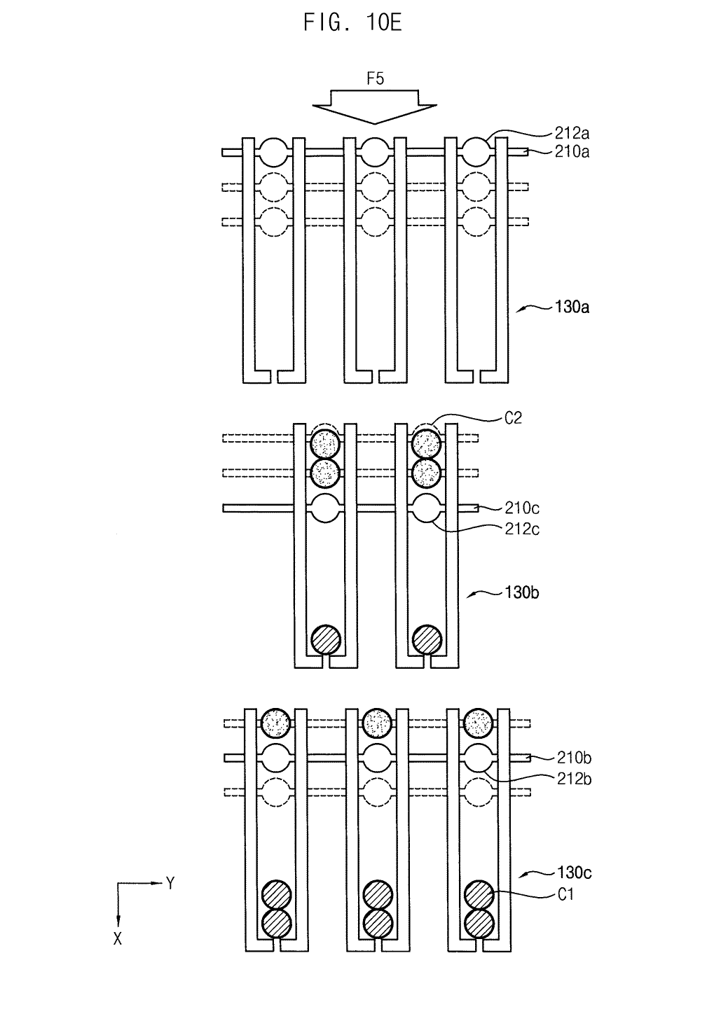

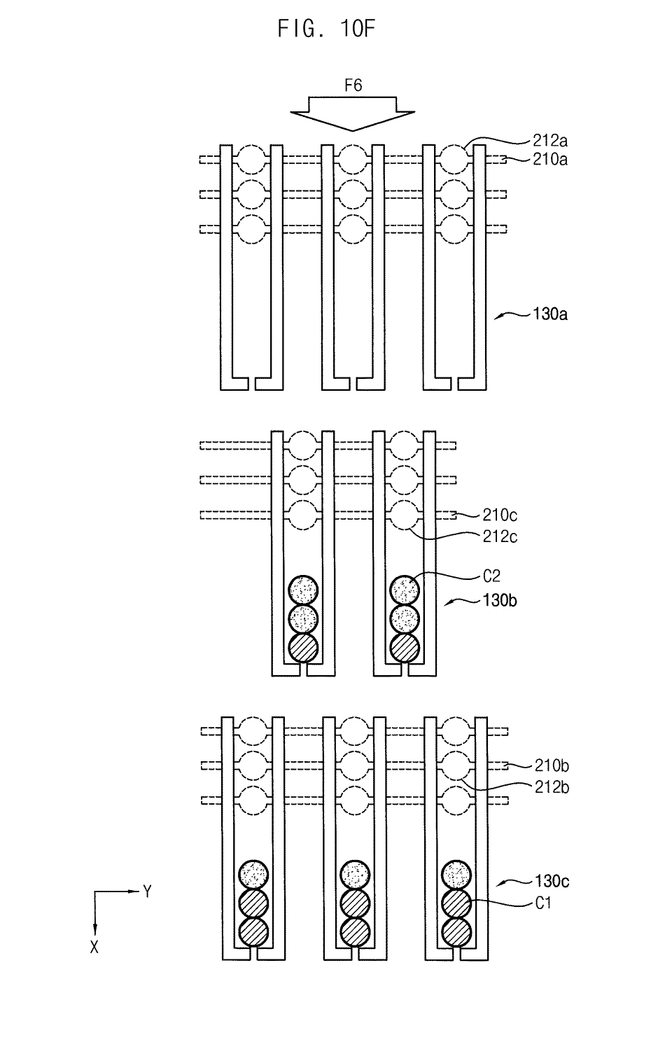

FIGS. 10A to 10F are plan views illustrating a method of arranging micro-particles in accordance with example embodiments.

Referring to FIG. 10A, first, an air pressure may be applied to the first membrane control line 210a that extends across the capturing structures 120 of the first capturing array 130a, and the air pressure may deform the first gate membrane portion 202a. An air pressure may be applied to the second membrane control line 210b that extends across the capturing structures 120 of the second capturing array 130b so as to deform the second gate membrane portion 202b. Likewise, an air pressure may be applied to the third membrane control line 210c that extends across the capturing structures 120 of the third capturing array 130c so as to deform the third gate membrane portion 202c. Then, a first fluid F1, which includes first particles C1 may be introduced into the chamber 110 through the first input/output portion 150.

Thus, the inlet of the capturing structures 120 of the first capturing array 130a may be closed by the first gate membrane portion 202a such that the first particles C1 are blocked from entering the gate portions 122 of the capturing structures 120 of the first capturing array 130a.

The inlet of the capturing structures 120 of the second capturing array 130b may be opened, but the second gate membrane portion 202b of the capturing structures 120 of the second capturing array 130b may be deformed such that one first particle C1 may be allowed to enter the gate portions 122 of the capturing structures 120 of the second capturing array 130b and be retained therein temporarily.

The inlet of the capturing structures 120 of the third capturing array 130c may be opened, but the third gate membrane portion 202c may be deformed such that two first particles C1 may be allowed to enter the gate portions 122 of the capturing structures 120 of the third capturing array 130c and be retained therein temporarily.

Referring to FIG. 10B, a second fluid F2 without particles may be introduced into the chamber 110 through the first input/output portion 150 and drained from the chamber 110 through the second input/output portion 160. Thus, uncaptured particles C1 may be discharged from the chamber 110.

Referring to FIG. 10C, the air pressure may be discharged from the first, second and third membrane control lines 210a, 210b, 210c so as to return the first, second and third gate membrane portions 202a, 202b, 202c to their original positions elastically. Subsequently, a third fluid F3 without particles may be introduced into the chamber 110 through the first input/output portion 150 so as to urge the first particles C1 temporarily retained in the respective gate portions 122 to the respective receiving portions 124.

Thus, a first particle C1 may not be captured in the receiving portions 124 of the capturing structures 120 of the first capturing array 130a. One first particle C1 may be captured in the receiving portions 124 of the capturing structures 120 of the second capturing array 130b. Two first particles C1 may be captured in the receiving portions 124 of the capturing structures 120 of the third capturing array 130c.

Referring to FIG. 10D, an air pressure may be applied to the first membrane control line 210a that extends across the capturing structures 120 of the first capturing array 130a so as to deform the first gate membrane portion 202a. An air pressure may be applied to the third membrane control line 210c that extends across the capturing structures 120 of the second capturing array 130b so as to deform the third gate membrane portion 202c. An air pressure may be applied to the second membrane control line 210b that extends across the capturing structures 120 of the third capturing array 130c so as to deform the second gate membrane portion 202b. Subsequently, a fourth fluid F4 that includes second particles C2 may be introduced into the chamber 110 through the first input/output portion 150.

Thus, the inlets of the capturing structure 120 of the first capturing array 130a may be closed by the first gate membrane portion 202a such that the second particles C1 may be blocked from entering the gate portions 122 of the capturing structures 120 of the first capturing array 130a.

The inlets of the capturing structures 120 of the second capturing array 130b may be opened, but the third gate membrane portion 202c may be deformed such that two second particles C2 may be allowed to enter the gate portions 122 of the capturing structures 120 of the second capturing array 130b and be retained therein temporarily.

The inlets of the capturing structures 120 of the third capturing array 130c may be opened, but the second gate membrane portion 202b may be deformed such that one second particle C2 may be allowed to enter the gate portions 122 of the capturing structures 120 and be retained therein temporarily.

Referring to FIG. 10E, a fifth fluid F5 that does not include particles may be introduced into the chamber 110 through the first input/output portion 150 and drained from the chamber 110 through the second input/output portion 160. Thus, uncaptured particles C2 may be removed from the chamber 110.

Referring to FIG. 10F, the air pressure may be discharged from the first, second and third membrane control lines 210a, 210, 210c to return the first, second and third gate membrane portions 202a, 202b, 202c to their original positions elastically. Then, a sixth fluid F6 without particles may be introduced into the chamber 110 so as to urge the temporarily retained second particles C2 from the respective gate portions 122 to the respective receiving portions 124.

Thus, a second particle C2 may not be captured in the receiving portions 124 of the capturing structures 120 of the first capturing array 130a. Two second particles C2 and one first particle C1 may be captured in the receiving portions 124 of the capturing structures 120 of the second capturing array 130b. One second particle C2 and two first particles C1 may be captured in the receiving portions 124 of the capturing structures 120 of the third capturing array 130c.

As mentioned above, the particle arranging device 10 may be a micro-fluidic device including a reversibly actuatable micro-balloon actuator arranged in a fluidic channel of a capturing structure. The micro-balloon actuator may be used as a resisting structure in the fluidic channel to control the number of particles to enter the capturing structure.

Accordingly, the particle arranging device 10 may provide a high-throughput self-arrangement of the micro-particles, excellent reproducibility, and a simple combination arrangement of different types of particles.

In example embodiments, the particle arranging device 10 may further include a chemical or biological material layer coated on an inner wall defining the chamber 110 or the deformable membrane structure. The material layer may be formed on the inner wall defining the chamber 110 to increase or decrease an adhesive strength with the micro-particle. Alternatively, the material layer may be formed by performing a surface treatment on the surfaces defining the chamber 110. For example, the material layer such as, for example, a collagen may be coated on the first substrate 100.

Further, the particle arranging device 10 may include an additional structure fixed on the gate membrane portion or the surfaces defining the chamber 110 to assist with capturing a particle. The particle arranging device 10 may further include electrodes disposed on opposing sides of each of the capturing structures or the capturing arrays to count the particles.

FIG. 11 is a plan view illustrating membrane control lines of a particle arranging device in accordance with example embodiments.

Referring to FIG. 11, first, second and third membrane control lines 210a, 210b and 210c may include first, second and third membrane pressurizing portions 212a, 212b and 212c having a rectangular shape, respectively. It may be understood that a gate membrane portion may have various shapes in consideration of a shape and deformability of a particle to be captured, a shape of a capturing structure, etc.

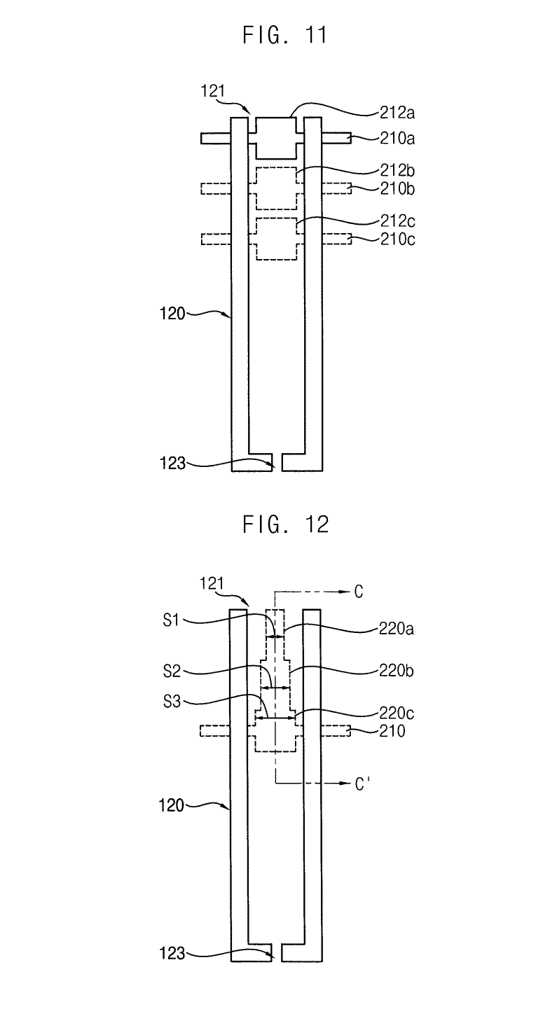

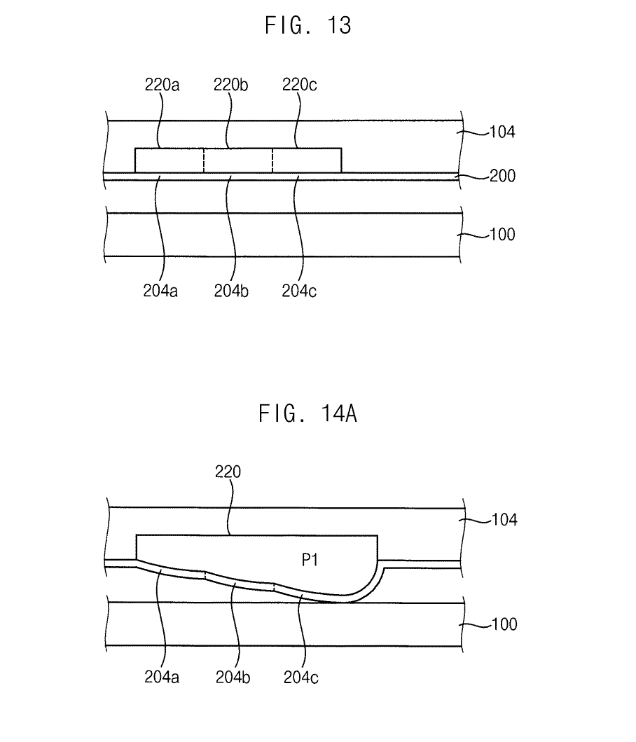

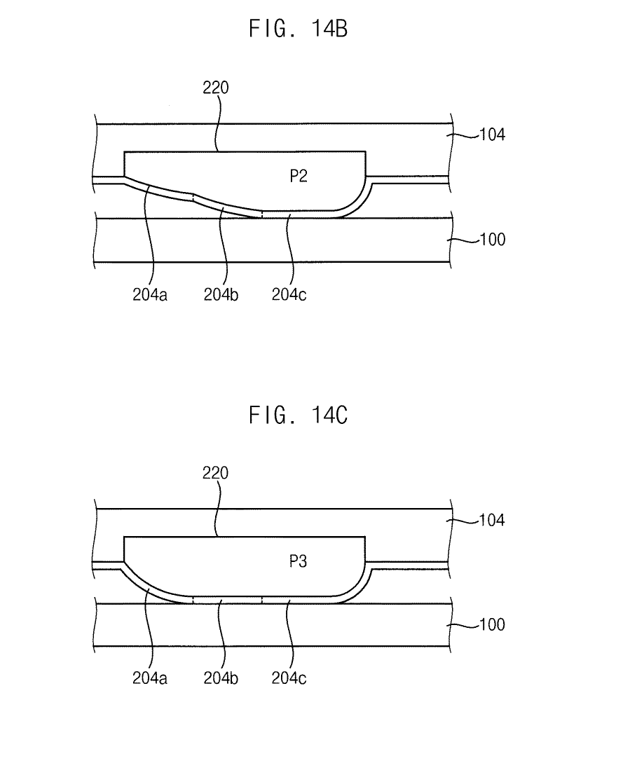

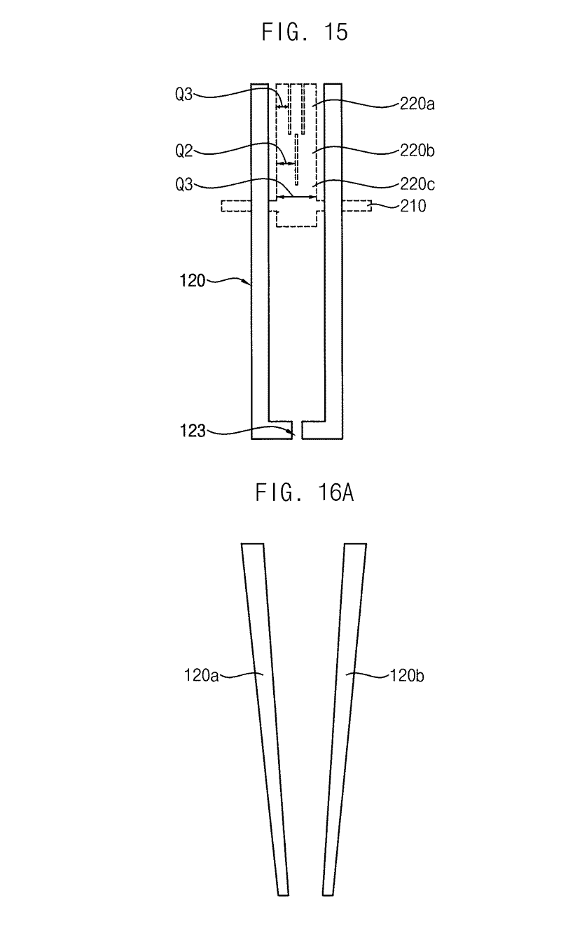

FIG. 12 is a plan view illustrating a membrane control line of a particle arranging device in accordance with example embodiments. FIG. 13 is a cross-sectional view taken along the C-C′ line in FIG. 12. FIGS. 14A to 14C are cross-sectional views illustrating deformation of gate membrane portions in FIG. 13.

Referring to FIGS. 12 and 13, a membrane control line 210 may include first, second and third membrane pressurizing portions 220a, 220b and 220c connected to each other and having different widths. The first membrane pressurizing portion 220a may have a first width S1, the second membrane pressurizing portion 220b may have a second width S2 greater than the first width S1, and the third membrane pressurizing portion 220c may have a third width S3 greater than the second width S2. Thus, first, second and third gate membrane portions 204a, 204b and 204c may have different final deformed positions respectively when a same pressure is applied.

Referring to FIGS. 14A to 14C, when a first pressure P1 is applied to the membrane control line 210, the third gate membrane portion 204c may be deformed to its final position to contact a surface of the first substrate 100 such that a gate portion of the capturing structure is closed to prevent a particle from entering the capturing structure. When a second pressure P2 greater than the first pressure P1 is applied to the membrane control line 210, the second gate membrane portion 204b may be deformed to its final position to contact the surface of the first substrate 100 such that the gate portion of the capturing structure is closed to prevent a particle from entering the capturing structure. When a third pressure P3 greater than the second pressure P2 is applied to the membrane control line 210, the first gate membrane portion 204a may be deformed to its final position to contact the surface of the first substrate 100 such that the gate portion of the capturing structure is closed to prevent a particle from entering the capturing structure.

Accordingly, the pressure applied to the membrane control line 210 may be adjusted to control the opening and closing state of the gate portion of the capturing structure, to thereby control the number of the particles to be captured in the capturing structure.

Although it is not illustrated in the figures, the first, second and third gate membrane portions may have different thicknesses. For example, the first gate membrane portion 204a may have a first thickness, the second gate membrane portion 204b may have a second thickness less than the first thickness, and the third gate membrane portion 204c may have a third thickness less than the second thickness.

FIG. 15 is a plan view illustrating a membrane control line of a particle arranging device in accordance with example embodiments.

Referring to FIG. 15, a membrane control line 210 may include first, second and third membrane pressurizing portions 220a, 220b and 220c connected to each other and having different widths. Three first membrane pressurizing portions 220a may have a first width Q1 respectively, two second membrane pressurizing portions 220b may have a second width Q2 greater than the first width Q1, and one third membrane pressurizing portion 220c may have a third width Q3 greater than the second width Q2. Thus, first, second and third gate membrane portions may have different final deformed positions respectively when a same pressure is applied.

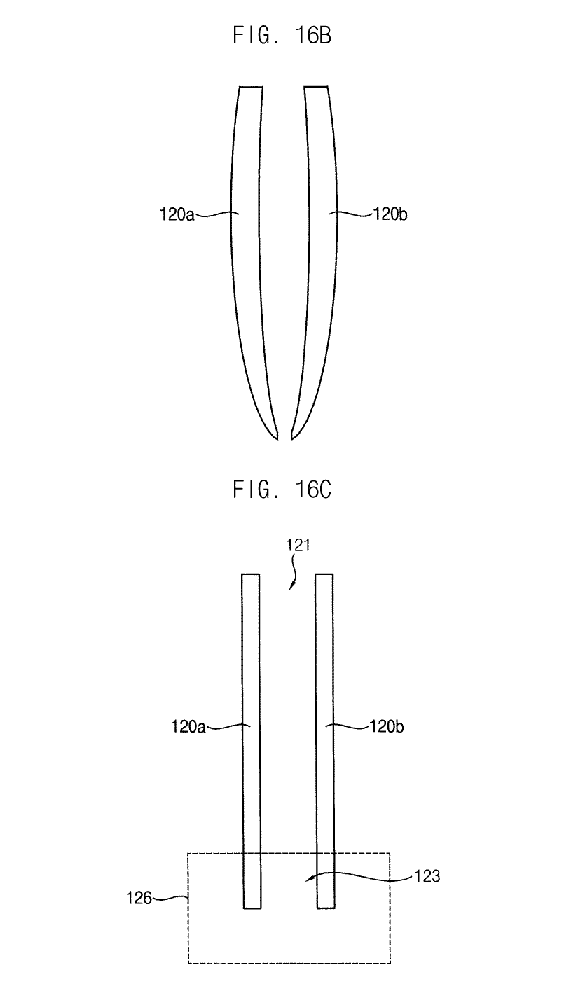

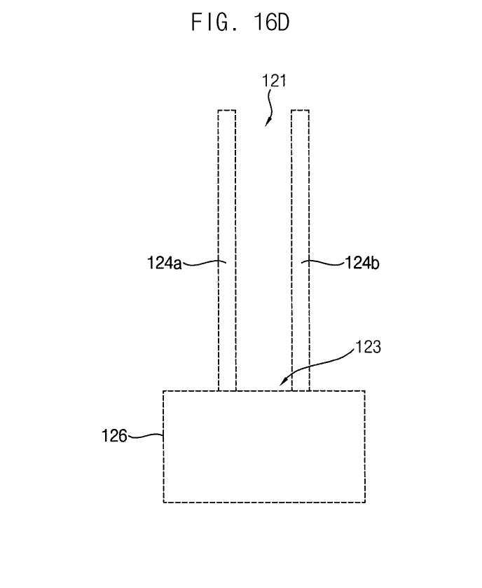

FIGS. 16A to 16D are plan views illustrating a capturing structure of a particle arranging device in accordance with example embodiments.

Referring to FIGS. 16A and 16B, a pair of first and second elongated channel patterns 120a and 120b of a capturing structure may be symmetric to each other. A distance between the first and second elongated channel patterns may be changed along an extending direction thereof to form an inlet and an outlet of the capturing structure 120. Widths of the first and second elongated channel patterns 120a and 120b may be changed along the extending direction.

Referring to FIGS. 16C and 16D, a capturing structure may include at least one fixed pattern and a deformable pattern. As illustrated in FIG. 16C, a pair of fixed patterns 120a and 120b and one deformable pattern 126 may form an inlet 121 and an outlet 123 of the capturing structure. The deformable pattern 126 may be deformed by an air pressure to form a receiving portion and the outlet 123 of the capturing structure. As illustrated in FIG. 16D, a pair of fixed patterns 124a and 124b and one deformable pattern 123 may be deformed by an air pressure to form the capturing structure.

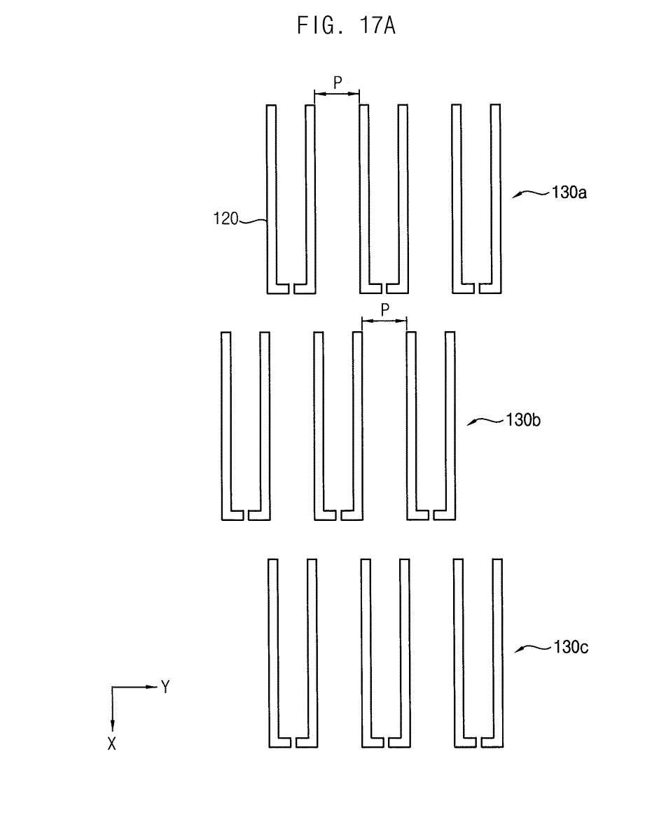

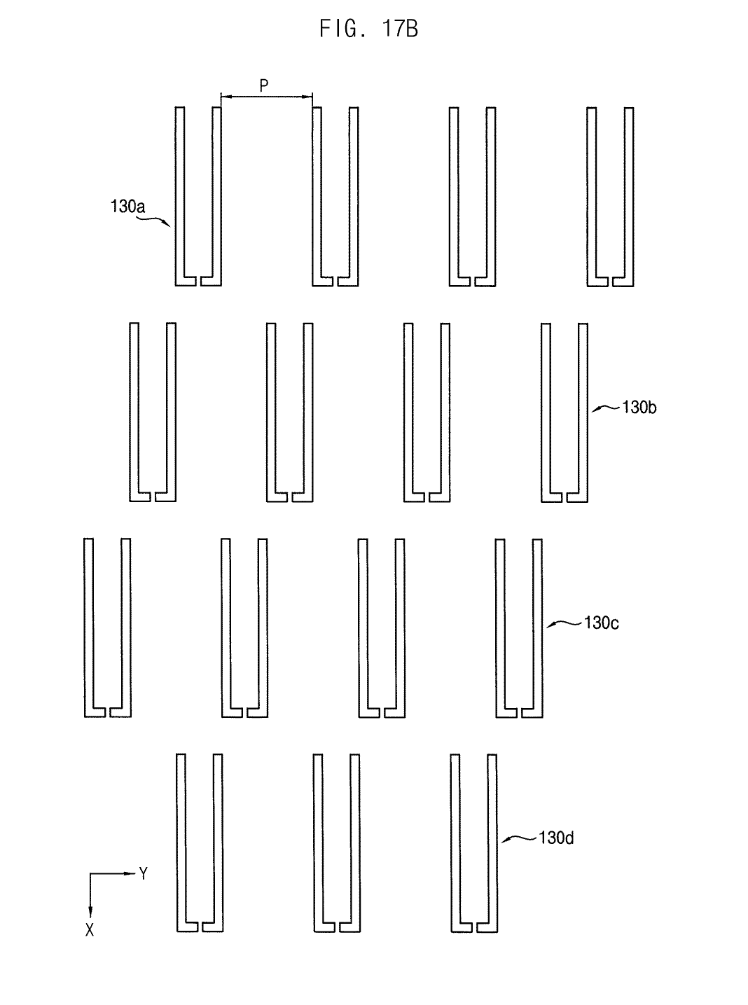

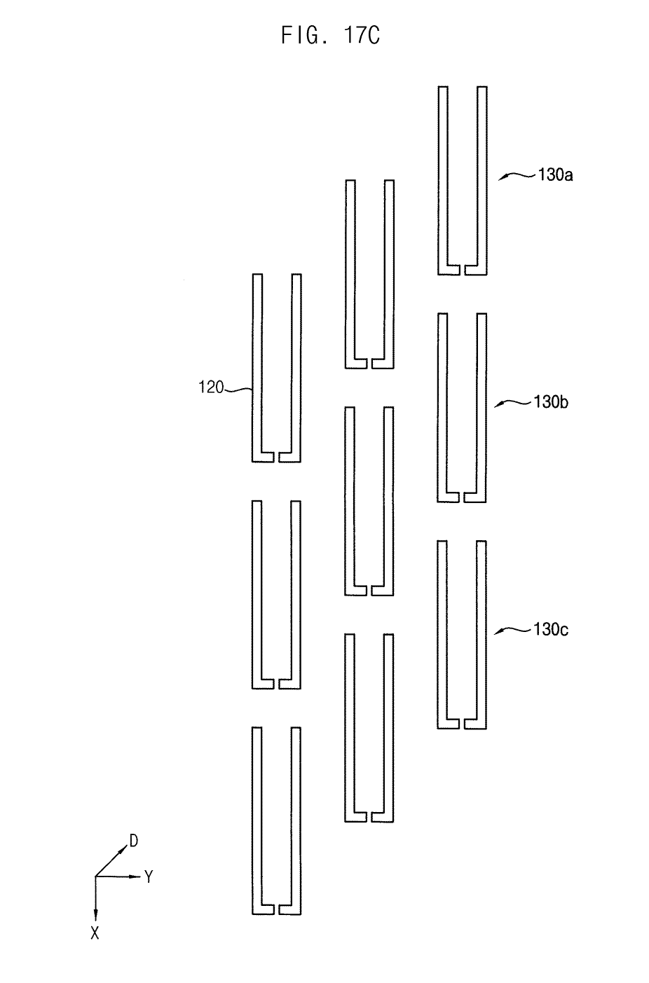

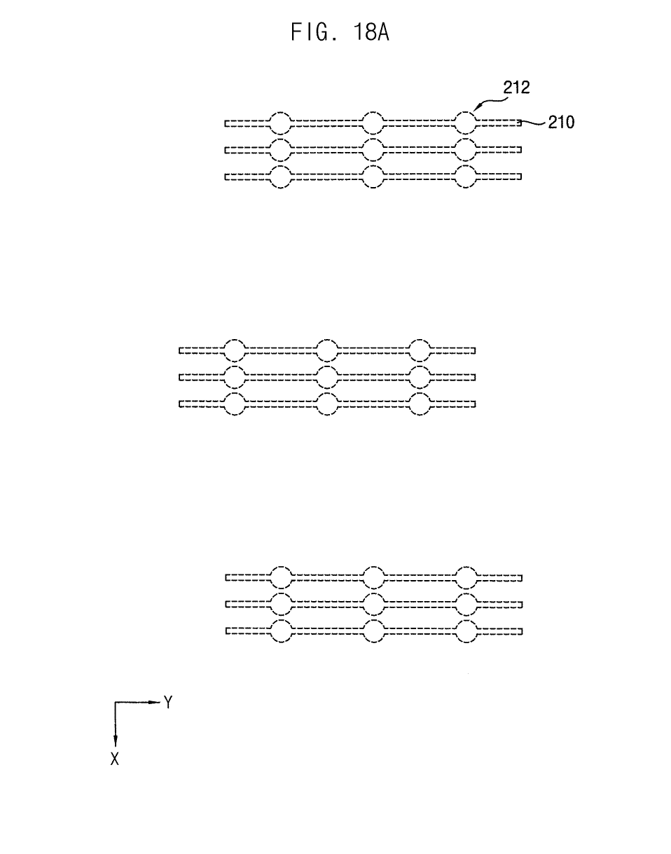

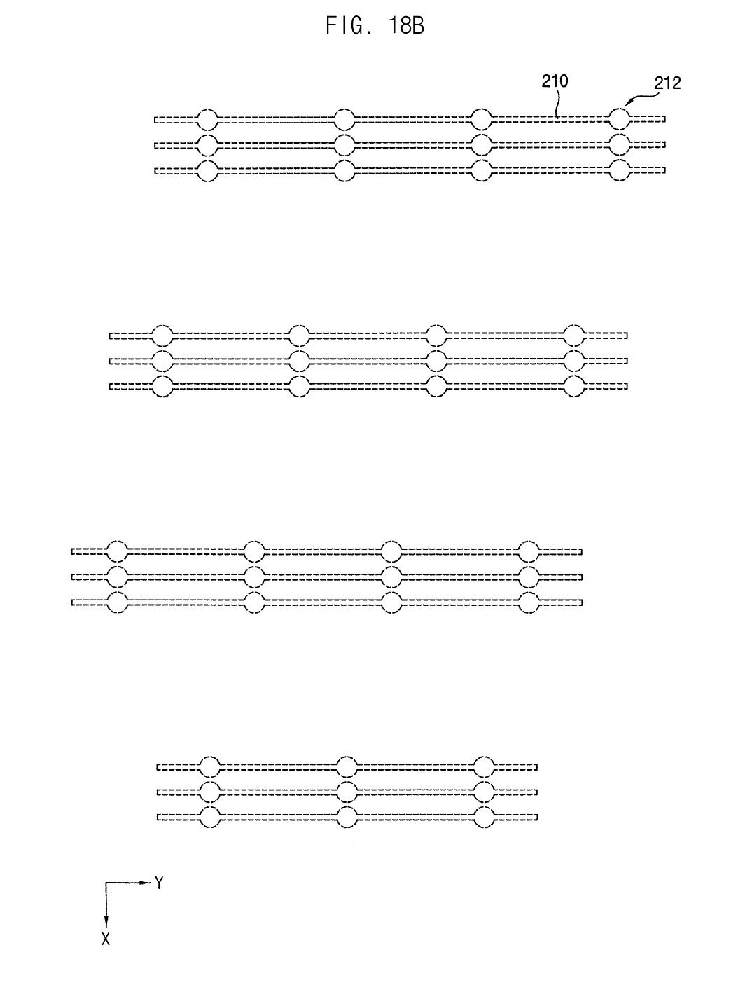

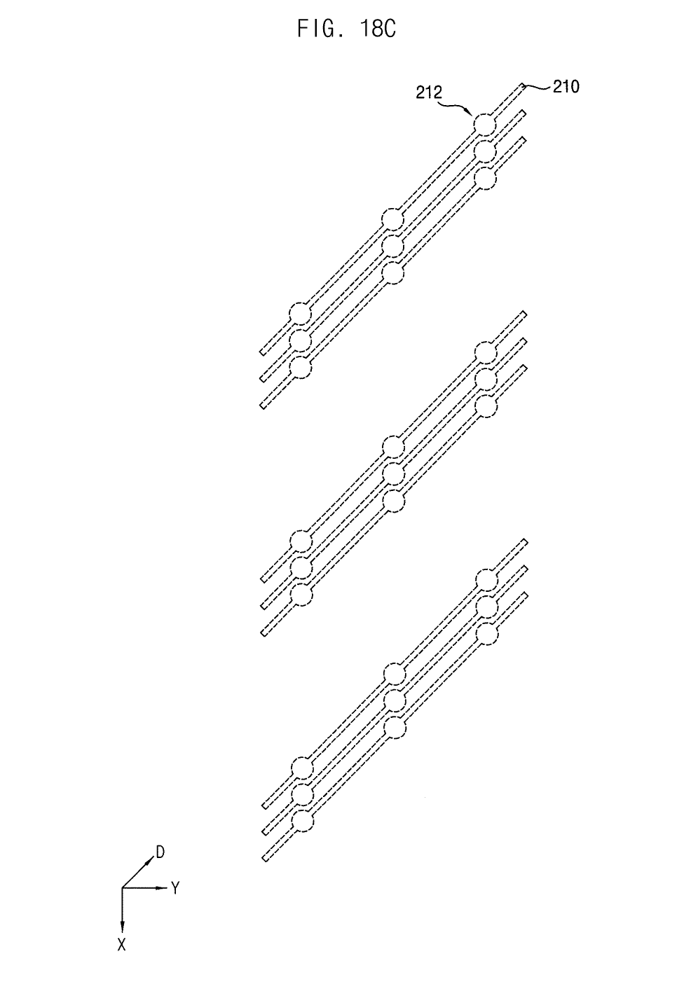

FIGS. 17A to 17C are plan views illustrating capturing arrays of a particle arranging device in accordance with example embodiments. FIGS. 18A to 18C are plan views illustrating membrane control lines respectively corresponding to the capturing arrays in FIGS. 17A to 17C.

Referring to FIGS. 17A and 17B and FIGS. 18A and 18B, capturing arrays 130a, 130b and 130c may include a plurality of capturing structures 120 arranged in a second direction (Y direction). The capturing arrays 130a, 130b and 130c may be arranged in a first direction (X direction). A membrane control line 210 may extend in the second direction, and a plurality of the membrane control lines 210 may be arranged to be spaced apart from each other in the first direction. The membrane control lines 210 may include a plurality of membrane pressurizing portions 212 sequentially arranged in the first direction in the capturing structure 120. A distance P between the capturing structures 120, a distance between the membrane pressurizing portions and a size of the membrane pressurizing portion may be determined in consideration of the arrangement of the capturing structures, a size of a particle, etc.

Referring to FIGS. 17C and 18C, capturing arrays 130a, 130b and 130c may include a plurality of capturing structures 120 arranged in a third direction (D direction) different from the second direction (Y direction). A membrane control line 210 may extend in the third direction, and a plurality of the membrane control lines 210 may be arranged to be spaced apart from each other in the first direction.

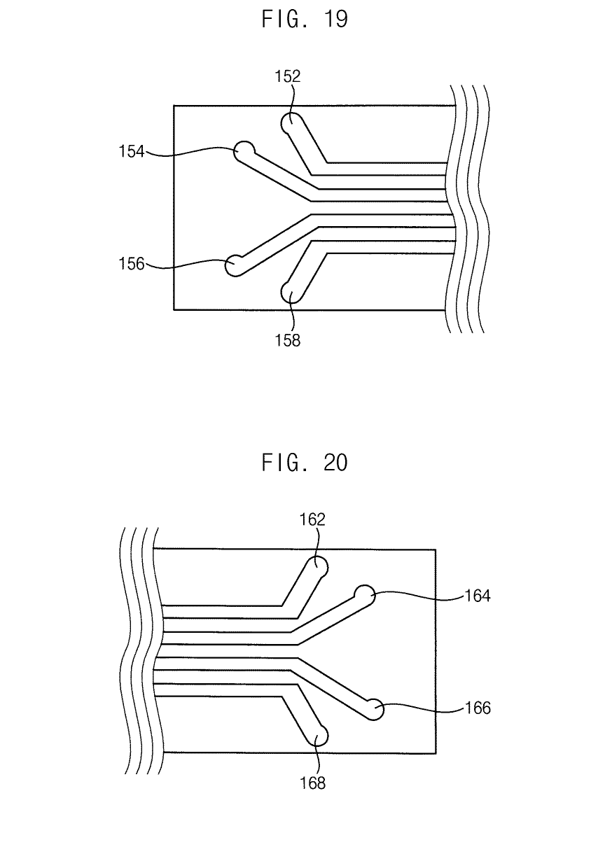

FIG. 19 is a plan view illustrating a first input/output portion in accordance with example embodiments.

Referring to FIG. 19, a first input/output portion may include a plurality of inflow/outflow portions 152, 154, 156, 158. A fluid containing particles may flow into a chamber through the inflow/outflow portions. Alternatively, fluid having different types of particles may be introduced into the chamber through the inflow/outflow portions sequentially or simultaneously. Some of the inflow/outflow portions may provide a pressure for fluid flow or supply a fluid for collecting particles or for cleaning the chamber.

FIG. 20 is a plan view illustrating a second input/output portion in accordance with example embodiments.

Referring to FIG. 20, a second input/output portion may include a plurality of inflow/outflow portions 162, 164, 166, 168. A fluid having particles may be drained from a chamber through the inflow/outflow portions. Same or different types of particles may be collected through the inflow/outflow portions. Some of the inflow/outflow portions may provide a pressure for fluid flow or supply a fluid for collecting particles or for cleaning the chamber.

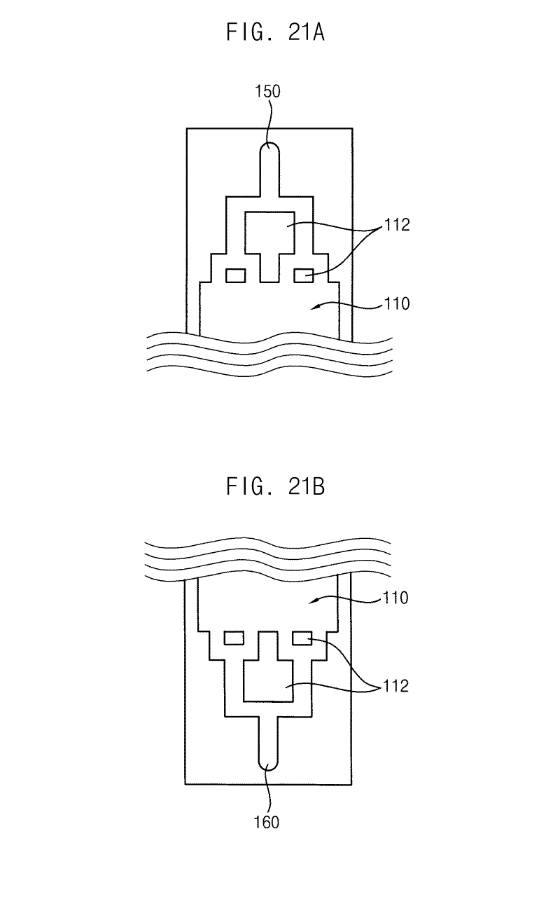

FIGS. 21A and 21B are plan views illustrating a chamber of a particle arranging device in accordance with example embodiments.

Referring to FIGS. 21A and 21B, a particle arranging device may further include a guiding structure 112 arranged in a chamber 110. The guiding structure 112 may guide a fluid to run smoothly (i.e., laminar flow) through the chamber 110. The guiding structure may control a mixture of fluids or a distribution of fluid flow.

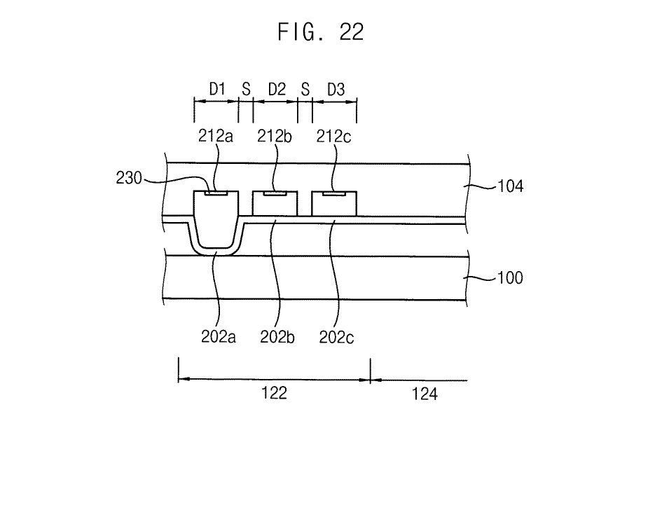

FIG. 22 is a cross-sectional view illustrating a particle arranging device in accordance with example embodiments. The particle arranging device is substantially the same as or similar to the particle arranging device described with reference to FIGS. 1 to 7, except a membrane control heater. Thus, the same or like reference numerals will be used to refer to as the same or like elements and any repetitive explanation concerning the above elements will be omitted.

Referring to FIG. 22, a particle arranging device may include a membrane control heater 230 as a membrane control portion configured to deform a deformable membrane structure. The membrane control heater 230 serving as the membrane control portion may selectively deform the deformable membrane structure instead of a membrane control line or together with the membrane control line.

The membrane control heater 230 may include first, second and third membrane control heaters configured to deform first, second and third gate membrane portions 202a, 202b and 202c respectively. The first, second and third membrane control heaters may be disposed in first, second and third membrane pressurizing portions 212a, 212b and 212c respectively. The membrane control heaters may increase the temperature in the membrane pressurizing portion to expand an internal air such that the gate membrane portion may be deformed. That is, the membrane pressurizing portion and the gate membrane portion may form an airtight space, and the membrane control heater may be disposed within the airtight space to increase the temperature of the internal air, and thus cause the internal air to expand and deform the gate membrane portions respectively.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present inventive concept. Accordingly, all such modifications are intended to be included within the scope of the present inventive concept as defined in the claims. In the claims, means-plus-function clauses are intended to cover the structures described herein as performing the recited function and not only structural equivalents but also equivalent structures. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

That which is claimed is:

1. A particle arranging device comprising:
a chamber including a first input/output portion and a second input/output portion, the chamber configured to provide a space through which a fluid containing particles flows;
at least one capturing structure disposed within the chamber configured to form a fluidic channel through which the fluid flows, the at least one capturing structure including a gate portion configured to allow the particle in the fluid to enter the capturing structure through the gate portion and a receiving portion configured to receive the particle through the gate portion;
a deformable membrane structure disposed proximate the gate portion of the capturing structure and configured to actuate to control the number of the particles entering the capturing structure through the gate portion; and
a membrane control portion configured to apply a force to the deformable membrane structure.

2. The device of claim 1, wherein the capturing structure comprises at least first and second channel patterns formed on an inner wall defining the chamber, the first and second channel patterns configured to form the fluidic channel.

3. The device of claim 2, wherein the first and second channel patterns are arranged to face each other to form the gate portion and the receiving portion.

4. The device of claim 1, wherein the deformable membrane structure comprises a plurality of gate membrane portions arranged sequentially in the gate portion along a direction the gate portion extends.

5. The device of claim 4, wherein the gate membrane portion is deformed by the force so as to block the particle from entering through the gate portion.

6. The device of claim 4, wherein the gate membrane portion has a width capable of blocking the particle from entering through the gate portion.

7. The device of claim 4, wherein the membrane control portion comprises a membrane pressurizing portion adapted to apply the force to the gate membrane portion.

8. The device of claim 7, wherein a plurality of the membrane pressurizing portions is arranged to correspond to the gate membrane portions.

9. The device of claim 1, wherein the membrane control portion comprises a recess formed in an inner wall defining the chamber that extends across the gate portion of the capturing structure.

10. The device of claim 9, wherein the deformable membrane structure comprises a deformable membrane to cover the recess.

11. The device of claim 1, wherein the membrane control portion is connected to a pneumatic supply source and configured to deform a gate membrane portion of the deformable membrane structure.

12. The device of claim 1, wherein the membrane control portion comprises:
a membrane pressurizing portion to form an airtight space with the deformable membrane structure; and
a membrane control heater disposed in the airtight space configured to increase the temperature within the airtight space, thereby deforming the gate membrane portion.

13. The device of claim 1, wherein a plurality of the capturing structures is arranged in a first direction to form one capturing array, and a plurality of the capturing arrays is arranged in a second direction substantially perpendicular to the first direction.

14. A particle arranging device comprising:
a chamber including a first input/output portion and a second input/output portion, the chamber configured to provide a space through which a fluid containing particles flows;
at least one capturing array including a plurality of capturing structures, at least one capturing structure disposed within the chamber to form a fluidic channel through which the fluid flows, the at least one capturing structure including a gate portion configured to allow the particle in the fluid to enter the at least one capturing structure through the gate portion and a receiving portion configured to receive the particle entering through the gate portion;
a deformable membrane structure including at least one gate membrane portion, the at least one gate membrane portion disposed proximate each of the gate portions of the capturing structures and configured to actuate to control the number of the particles entering the capturing structure through the gate portion; and
a membrane control line including a membrane pressurizing portion, the membrane pressurizing portion extending across the gate portions of the capturing structures and configured to apply a pressure to the gate membrane portion.

15. The device of claim 14, wherein the capturing structure comprises at least first and second channel patterns formed on an inner wall defining the chamber, the first and second channel patterns configured to form the fluidic channel.

16. The device of claim 14, wherein a plurality of the gate membrane portions arranged sequentially in the gate portion along a direction the gate portion extends.

17. The device of claim 14, wherein the receiving portion has a length greater than a length of the gate portion.

18. The device of claim 14, wherein the capturing structures are arranged in a first direction, and a plurality of the capturing arrays is arranged in a second direction, the second direction being substantially perpendicular to the first direction.
